(19) United States
(12) Patent Application Publication
(10) Pub. No.: US 2005/0063462 A1
(43) Pub. Date: Mar. 24, 2005

(54) Visual scan method using scan table and discrete cosine transform device employing the same method

(75) Inventor: Seung-Cheol Lee, Yongin-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/928,395

(22) Filed: Aug. 27, 2004

(30) Foreign Application Priority Data
Sep. 18, 2003 (KR) 64779/2003

(51) Int. Cl. H04N 7/12

(52) U.S. Cl. 375/240.03; 375/240.2; 375/240.24

(57) ABSTRACT

Disclosed is a visual scan method using scan table capable of determining an exact scan method according to blocks in discrete cosine transform (DCT) even in special circumstances, and a discrete cosine transform device employing the same method. The discrete cosine transform device includes: a scan table generation section for accumulatively summing absolute values of the coefficients obtained through a DCT operation, in such a manner that the absolute values in pixels located at the same position of each unit video block in a predetermined video block group are summed together by the predetermined video block group with respect to an input video, and then for generating a scan table according to the magnitudes of the summed absolute values; a bit-rate calculation section for calculating an amount of bits by accumulatively summing only bit lengths of a variable length coding (VLC) table, the VLC table being obtained from the values arranged according to the scan table generated in the scan table generation section; and a scan control section for receiving the input video having been discrete-cosine-transformed, inputting the received video to the scan table generation section to generate a scan table by the predetermined video block group, receiving a value of a bit rate according to generation of the scan table from the bit-rate calculation section, and performing a control operation using capacity increase of the scan table and the bit rate to provide a scan table for scanning according to the scan method.

### PRIORITY

This application claims priority to an application entitled “Visual Scan Method Using Scan Table and Discrete Cosine Transform Device Employing The Same Method” filed in the Korean Industrial Property Office on Sep. 18, 2003 and assigned Serial No. 2003-64779, the contents of which are hereby incorporated by reference.

### BACKGROUND OF THE INVENTION

1. Field of the Invention

The present invention relates to the transmission and reception of video information, and more particularly to a discrete cosine transform.

2. Description of the Related Art

In general video transmission, a video transmission device compresses video data for transmission. In order to compress video data, the video transmission device transforms the video data from a spatial region to a frequency region. To this end, the most widely-used transform method is a discrete cosine transform (hereinafter, referred to as ‘DCT’) method. Since the DCT method has advantages of video energy compaction and a fast processing speed, it is now used as a standard compression method for still image and moving images.

When a video (square shape) is transformed into a frequency region as described above, a major energy is gathered together at a top-left part while high frequency components are gathered together at a bottom-right part, as represented in FIG. 1, which is an illustration of signal distribution in a two-dimensional 8×8 DCT.

Referring to FIG. 1, frequency transform of a video signal according to DCT is achieved in such a manner that the video signal is processed sequentially in one dimension respectively in a horizontal direction and a vertical direction, so that a two-dimensional frequency signal is obtained. In general, a value of a direct current (DC), which is a coefficient indicating a top-left corner pixel, represents an average energy of a whole video having an 8×8 size and is the largest value.

Coefficients of the other 63 pixels are alternative currents (AC), which represent higher frequency components as the distance from the direct current increases and have smaller values as they get to higher frequencies.

The exemplary view illustrated in FIG. 1, shows each of the 64 DCT coefficients as frequency functions.

At a state in which a block is represented as the coefficient values of the frequency components as described above, values of high frequency components which are relatively smaller in comparison with other values converge to ‘0’ or a small value near ‘0’ through quantization and scanning is performed in a zigzag shape from a top-left corner to a bottom-right corner in order to detect the values.

According to the zigzag scanning, which has been known to utilize characteristics of the DCT well, a variable length coding (VLC) is performed by efficiently separating ‘0’ or small values near ‘0’, which are high frequency components from high values, which are low frequency components. Such a process has been commonly adopted in MPEG (Moving Picture Experts Group) 1, 2, and 4, H.261, 263, and 264, JPEG (Joint Photographic Experts Group), etc.

In a state where the DCT and the quantization have been performed, the video data are in an arrangement in which they are stored from the left to the right in the upper end and downward from the upper end. This is because a frequency conversion unit is appointed to a square of 8×8 size. However, after the DCT, coefficients become significantly smaller according to progression in a radial direction from the top-left corner to the bottom-right corner in the block. Particularly, when a quantization process has been performed, most of the high frequency components converge to ‘0’. In a case in which the variable length coding is performed according to the form in which the coefficients are stored, that is, from left to right in the upper end and downward from the upper end, it is difficult to sufficiently utilizean advantage of an easy-compressible form obtained through the DCT. Accordingly, scanning, in separating the high frequency components and the low frequency components from each other, becomes necessary.

FIGS. 2A to 2C are exemplary views for illustrating conventional scan methods of a two-dimensional 8×8 DCT signal. An object of the scan method is that scanning is performed so that coefficients are sequentially arranged from a largest value to a smallest value. The reason for this is that a compression effect through the variable length coding becomes greater when the coefficients are sequentially arranged.

FIG. 2A shows a zigzag scan method, which is used in DCT compression of a general video. FIG. 2B shows a vertical scan method, which is used in a case in which vertical components are strong. FIG. 2C shows a horizontal scan method which is used in DCT compression when horizontal components are strong. The scan methods shown in FIGS. 2A to 2C are currently adopted in the MPEG4 standard. Through the scan method, a characteristic of the DCT is maximized, and the variable length cording (VLC) is performed.

FIG. 3 is a block diagram showing a construction of an example of a conventional H.263/MPEG video encoder. As shown in FIG. 3, a conventional H.263/MPEG video encoder includes a raw image memory 301, a first operation section 302, a discrete cosine transform (DCT) section 303, a quantization (Q) section 304, an inverse quantization (IQ) section 305, an inverse discrete cosine transform (IDCT) section 306, a coupler 307, a recon memory 308, a motion estimation section 310, a motion compensation section 309, an Mced memory 311, a scan section 312, and a variable length coding (VLC) section 313. The raw image memory 301 receives video information by the frame and stores the received video information. The first operation section 302 performs an operation of the received raw video information with motion-compensated information stored in the Mced memory 311 and transmits the result of the operation to the DCT section 303. The DCT section 303 performs a discrete cosine transform. The quantization (Q) section 304 quantizes the output of the DCT section 303. The inverse quantization (IQ) section 305 inverse-quantizes previously quantized data from quantization section 304. The IDCT section 306 performs an inverse discrete cosine transform for the output of the inverse quantization section 305. The coupler 307 couples the motion-compensated information of a previous frame (n−1) stored in the Mced memory 311 and decoding information of a current frame (n) decoded by the IDCT section 306. The recon memory 308 stores decoding information for the next frame (n). The motion estimation section 310 receives the decoding information of a previous frame (n−1) stored in the recon memory 308 and a raw video of a current frame (n), and then outputs a differential image and a motion vector for motion estimation. The motion compensation section 309 receives the output of the motion estimation section 310 and decoding information of a previous frame (n−1) stored in the recon memory 308 and compensates motion of the decoding information of the previous frame. The Mced memory 311 stores information of a previous frame (n−1), which has been motion-compensated. The scan section 312 scans quantization signals according to a scan method and stores a scanning sequence. The VLC section 313 performs entropy coding to assign a lower bit rate to a more-frequently appearing value and assign a higher bit rate to a less-frequently appearing value.

A scan method is determined and performed by the scan section 312 shown in FIG. 3. However, since each of the video blocks has different distributions of coefficients obtained through the DCT, it is difficult to satisfy an optimum scanning condition in a case in which one of uniform scan methods shown in FIG. 2A to 2C is adopted.

Accordingly, a number of studies have been made on ways determining one of a few scan methods for each of video blocks. Representative examples are U.S. Pat. No. 5,500,678 entitled “Optimized Scanning of Transform Coefficients in Video Coding”, U.S. Pat. No. 6,263,026 entitled “Signal Compressing System”, and Korean Patent Application No. 2002-00709 entitled “Estimation Scan Method of Transform Coefficients in Encoding of Still Image and Moving Image”, which is assigned to the assignee of the present application.

According to the “Optimized Scanning of Transform Coefficients in Video Coding” of U.S. Pat. No. 5,500,678, two scan methods which have been predetermined are selectively applied. This method is currently adopted as a scan method of an MPEG-4 intra coding, but it has a disadvantage in that a larger bit rate may be sometimes generated depending on object video comparison with using only a zigzag scan method.

The “Signal Compressing System” of U.S. Pat. No. 6,263,026, differs from the U.S. Pat. No. 5,500,678 in which the two scan methods are selectively applied. In that patent more scan methods have been predetermined to select the most appropriate scan methods, which are applied to DCT coefficients. That is, this method incorporates a technology of including still more scan methods so as to supplement the disadvantage of the scan method of the U.S. Pat. No. 5,500,678. However, in the case of U.S. Pat. No. 6,263,026, a separate storage is required in order to prepare a scan method, and a compression ratio of a portion of an object video can deteriorate when a prepared scan method does not fit the object video.

The Korean Patent Application No. 2002-00709, entitled “Estimation Scan Method of Transform Coefficients in Encoding of Still Image and Moving Image”, employs a technology of changing only the portion of the dynamic scan method for a corresponding region, which is different from the scan method of U.S. Pat. No. 5,500,678. According to the Korean Patent Application No. 2002-00709, probability that each of coefficients in the block is “non-zero” is calculated, and the scanning sequence is determined depending on the calculated probability. While such a method improves on the disadvantages of the two above-mentioned patent technologies, the method of determining a scanning sequence only by checking whether or not a DCT coefficient is ‘zero’ has a disadvantage in that good efficiency appears only in an ideal condition in which video is neither bright nor dark and a color difference signal is neither deep nor light.

According to the above-mentioned conventional scan methods, scan methods which seem to have a most compression efficiency in probability is predetermined as a standard, which are applied without any operation. The conventional scan methods can be regarded as being based on an assumption that video has high frequency components and low frequency components equally and a video signal in an 8×8 block has a uniform state, such that the video signal neither is partial to any one side nor has a special form (for example, a boundary face of a video). However, according to statistics in which videos are actually analyzed, it is known that there are many DCT blocks which do not follow the standard zigzag scan method.

Therefore, there is a need for a scan method that will provide better results in order to improve the effect of video compression.

### SUMMARY OF THE INVENTION

Accordingly, the present invention has been made to solve the above-mentioned problems occurring in the prior art, and an object of the present invention is to provide a visual scan method using scan table capable of determining an exact scan method according to blocks in discrete cosine transform (DCT) in special circumstances, and a discrete cosine transform device employing the same method.

Another object of the present invention is to provide a visual scan method capable of improving the defects of the conventional zigzag scan method and similar technologies and obtaining a greater compression ratio in special circumstances than the conventional method, without performing many additional operations than those performed in the conventional methods even when no existing zigzag scan method or similar technologies are employed.

In order to accomplish these objects, there is provided a discrete cosine transform (DCT) device using a scan table, performing a DCT operation on input video, quantizing the discrete-cosine-transformed video, scanning the quantized video according to a scan method, and outputting the scanned video as a compressed video stream through a variable length coding (VLC), the discrete cosine transform device comprising: a scan table generation section for accumulatively summing absolute values of coefficients obtained through the DCT operation, in such a manner that the absolute values in pixels located at the same position of each unit video block in a predetermined video block group are summed together by the predetermined video block group with respect to an input video, and then for generating a scan table according to magnitudes of the summed absolute values; a bit-rate calculation section for calculating an amount of bits by accumulatively summing only bit lengths of a VLC table, the VLC table being obtained from values arranged according to the scan table generated in the scan table generation section; and a scan control section for receiving the input video having been discrete-cosine-transformed, inputting the received video to the scan table generation section to generate a scan table by the predetermined block group, receiving a value of a bit rate according to generation of the scan table from the bit-rate calculation section, and performing a control operation using capacity increase of the scan table and the bit rate to provide a scan table for scanning according to the scan method.

In accordance with another aspect of the present invention, there is provided a visual scan method using a scan table in order to transmit a compressed video, the visual scan method comprising the steps of: (1) receiving a discrete-cosine-transformed video for the transmission of the compressed video; (2) determining a block group of a predetermined unit with respect to the received discrete-cosine-transformed video; (3) accumulatively summing and storing absolute values of coefficients obtained through a DCT process in such a manner that the absolute values in pixels located at the same position of each unit video block in a predetermined video block group are summed together and stored; (4) rearranging pixels in sequence of magnitudes of the summed absolute values according to positions of the pixels in a unit block, thereby generating a scan table; and (5) scanning the video according to the generated scan table.

### BRIEF DESCRIPTION OF THE DRAWINGS

The above and other objects, features and advantages of the present invention will be more apparent from the following detailed description taken in conjunction with the accompanying drawings, in which:

FIG. 1 is an exemplary view illustrating signal distribution in a two-dimensional 8×8 DCT;

FIGS. 2A to 2C are exemplary views illustrating conventional scan methods of a two-dimensional 8×8 DCT signal;

FIG. 3 is a block diagram showing a construction of an example of a conventional H.263/MPEG video encoder;

FIG. 4 is a block diagram showing a construction of an H.263/MPEG video encoder which determines a scan method and compresses/transmits a video according to one embodiment of the present invention;

FIG. 5 is a flow chart for a method of generating a scan table according to one embodiment of the present invention;

FIG. 6 is a flow chart of the generating method of a scan method explained in FIG. 5 when the generating method is applied to an 8×8 video; and

FIGS. 7A to 7F are exemplary views of comparing compression ratios of a visual scan method according to the present invention with those of a conventional visual scan method.

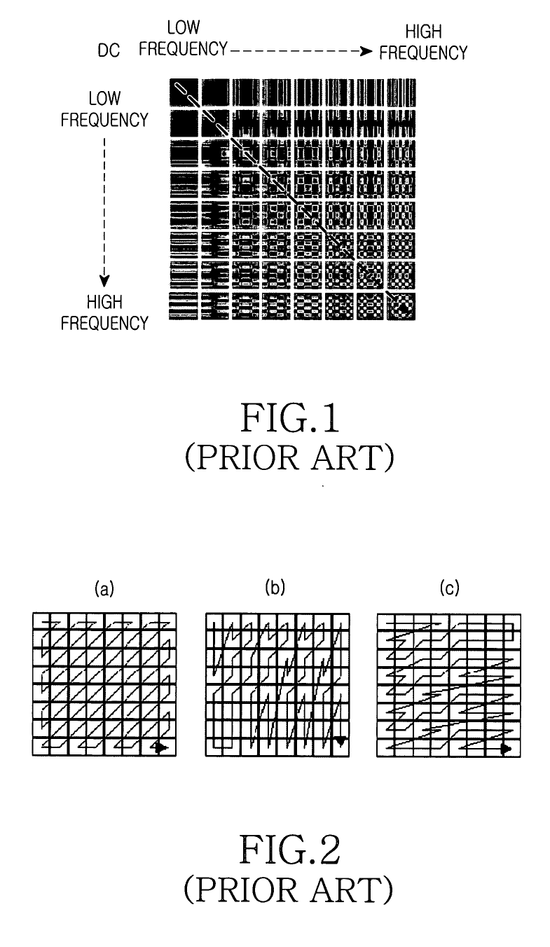

### DETAILED DESCRIPTION OF THE PREFERRED EMBODIMENT

Hereinafter, a visual scan method using a scan table and a discrete cosine transform device employing the same method according to preferred embodiments of the present invention will be described with reference to the accompanying drawings. It is to be noted that the same elements are indicated with the same reference numerals throughout the drawings. In the following description of the present invention, a detailed description of known functions and configurations incorporated herein will be omitted when it may obscure the subject matter of the present invention.

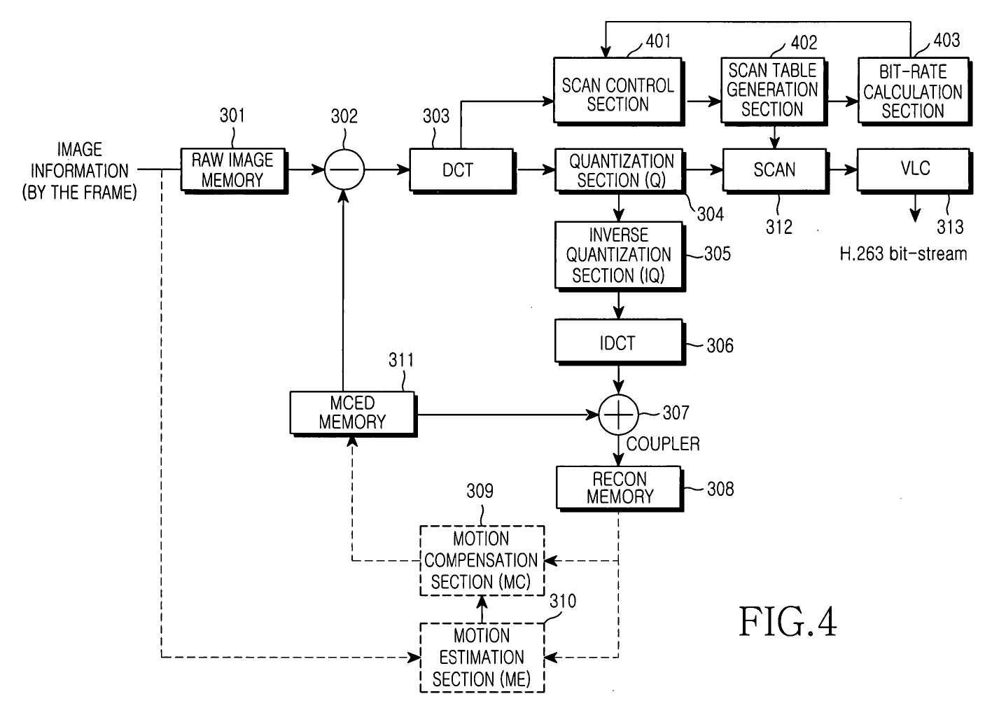

FIG. 4 is a block diagram showing a construction of an H.263/MPEG video encoder which determines a scan method and compresses/transmits a video according to one embodiment of the present invention.

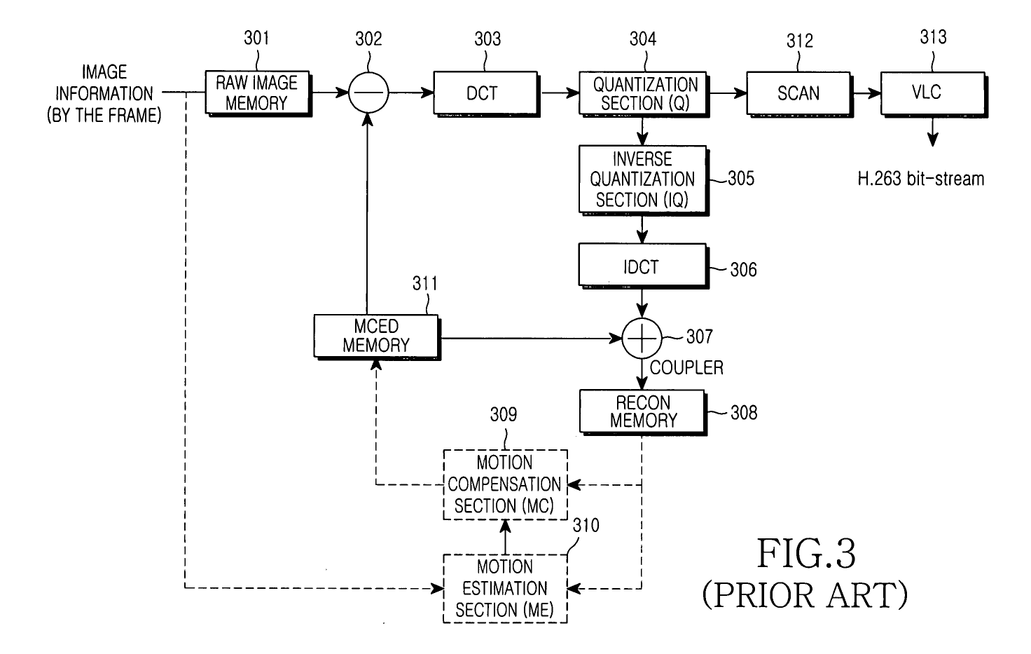

As shown in FIG. 4, some elements of the H.263/MPEG video encoder according to the present invention are similar to those of the general H.263/MPEG video encoder shown in FIG. 3. The H.263/MPEG video encoder according to the present invention includes a raw image memory 301, a first operation section 302, a discrete cosine transform (DCT) section 303, a quantization (Q) section 304, an inverse quantization (IQ) section 305, an inverse discrete cosine transform (IDCT) section 306, a coupler 307, a recon memory 308, a motion estimation section 310, a motion compensation section 309, an Mced memory 311, a scan section 312, and a variable length coding (VLC) section 313, which are the same elements as those shown in FIG. 3. In addition, the H.263/MPEG video encoder according to the present invention includes a scan control section 401, a scan table generation section 402, and a bit-rate calculation section 403. The raw image memory 301 receives video information by the frame and stores the received video information. The first operation section 302 performs an operation of the received raw video information with motion-compensated information stored in the Mced memory 311 and transmits the result of the operation to the DCT section 303. The DCT section 303 performs a discrete cosine transform. The quantization (Q) section 304 quantizes the output of the DCT section 303. The inverse quantization (IQ) section 305 inverse-quantizes quantized data from quantization section 304. The IDCT section 306 performs an inverse discrete cosine transform for the output of the inverse quantization section 305. The coupler 307 couples the motion-compensated information of a previous frame (n−1) stored in the Mced memory 311 and decoding information of a current frame (n) decoded by the IDCT section 306. The recon memory 308 stores decoding information for the next frame (n). The motion estimation section 310 receives the decoding information of a previous frame (n−1) stored in the recon memory 308 and a raw video of a current frame (n), and then outputs a differential image and a motion vector for motion estimation. The motion compensation section 309 receives the output of the motion estimation section 310 and decoding information of a previous frame (n−1) stored in the recon memory 308 and compensates motion of the decoding information of the previous frame. The Mced memory 311 stores information of a previous frame (n−1) which has been motion-compensated. The scan section 312 scans quantization signals according to a scan method and stores a scanning sequence. The VLC section 313 performs entropy coding to assign a lower bit rate to a more-frequently appearing value and assign a higher bit rate to a less-frequently appearing value.

The construction and the operation of the scan control section 401, the scan table generation section 402, and the bit-rate calculation section 403 in the H.263/MPEG video encoder according to the present invention will be described in more detail.

First, the function of each element will be explained. The scan table generation section 402 accumulatively sums absolute values of the coefficients obtained through the DCT operation, in such a manner that the absolute values in pixels located at the same position of each unit video block in an inputted video block group are summed together to form a summed absolute value. Then, the scan table generation section 402 generates a scan table which stores a scanning sequence according to the magnitudes of the summed absolute values.

The bit-rate calculation section 403 calculates an amount of bits by accumulatively summing only bit lengths from a VLC table. The VLC table is obtained from the values which are arranged by applying the scan table generated in an assigned scan table generation section 402 to a predetermined block.

The scan control section 401 compares a compression ratio calculated according to video division with capacity increase of a scan table, by using the bit rate of the bit-rate calculation section 403 according to the scan table and performs a control operation to provide an optimum scan table.

Video information discrete-cosine-transformed through the DCT section 303 is transmitted to the quantization section 304 and is simultaneously transmitted to the scan control section 401. The scan control section 401 transmits the received video information, which has been discrete-cosine-transformed, to the scan table generation section 402 so as to generate a scan table. The scan control section 401 determines whether or not a corresponding scan table is used as a scan method in the scan section 312, according to a result calculated in the bit-rate calculation section 403, which calculates a bit rate depending on a corresponding scan table.

The scan control section 401 and the scan table generation section 402, which determines a scan method by dividing blocks of video information into predetermined units, can determine an optimum block unit of video information by using results of calculations of the bit-rate calculation section 403.

The scan control section 401 and the scan table generation section 402 perform a calculation by one block unit of an 8×8 video frame (it is possible to adopt a predetermined size so as to correspond with a size of a video transform device such as DCT) and performs a calculation by an 8×8 video block unit for pixels corresponding to respective coordinates in a predetermined block group. Also, according to a result of each calculated bit amount, the scan control section 401 and the scan table generation section 402 transmit an optimum scan table to the scan section 312 so that a scan is performed according to the optimum scan table. According to the present invention as described above, a scan table is encoded during an encoding process in a transmission section, is transmitted to a receipt section, and is decoded during a decoding process in the receipt section. This is different from the conventional art in which a predetermined scan method is selected as appointed in a transmission section and a receipt section. In a case in which the capacity of a scan table becomes large, although a compression ratio is high, its effect is not sufficiently reflected. Therefore, it is necessary to provide an optimized scan table through trade-off between capacity of a scan table and a compression ratio using a bit rate. Such a control operation is performed by the scan control section 401. Particularly, whenever each block group is determined, a size of a scan table generated therefrom is constant, so a value of the size of the generated scan table is stored in the scan control section 401 and the bit-rate calculation section 403 receives a bit rate to control the value.

For example, with a frame of 10 Kbits, if a compression ratio for an ‘A’ block group is 50% and capacity of its scan table is 1 Kbits, capacity of transmission data becomes 6 Kbits. On the other hand, with a frame of 10 Kbits, if a compression ratio for a ‘B’ block group is 55% and capacity of its scan table is 0.3 Kbits, capacity of transmission data becomes 5.8 Kbits. As a result, the scan table of the ‘B’ block group becomes an optimum value, although the scan table of the ‘A’ block group is better when only a bit rate is considered. There is a tradeoff relationship between compression ratios and the capacity of a scan table, which can be represented by an equation:
Frame Size×Compression Ratio+Capacity Of Scan Table=Transmission Capacity.

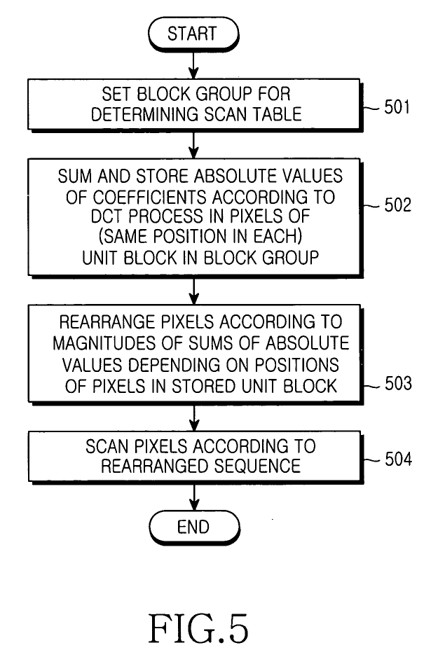

FIG. 5 is a flow chart for explaining a method of generating a scan table according to one embodiment of the present invention. According to the method of generating a scan table of the present invention, first, a block group for determining a scan table to arrange scan sequence is set in step 501. In other words, a unit of a block group for determining the scan table is determined.

Next, in respective blocks of the predetermined block group, absolute values of coefficients in pixels of the same position are summed and stored, in which the coefficients have been obtained through a DCT process in step 502. As a result, it becomes possible to arrange the pixels according to the magnitudes of the summed absolute values of coefficients located at the same position in the predetermined block group.

Then, the pixels are rearranged according to the magnitudes of the sums of absolute values depending on the positions of the pixels in the stored unit block, and thereby a scan table is generated in step 503. In other words, the summed absolute values stored at step 502 are arranged according to the magnitudes of the summed absolute values.

Then, in step 504, a scan is performed according to the generated scan table, that is, according to the sequence of the rearranged pixels.

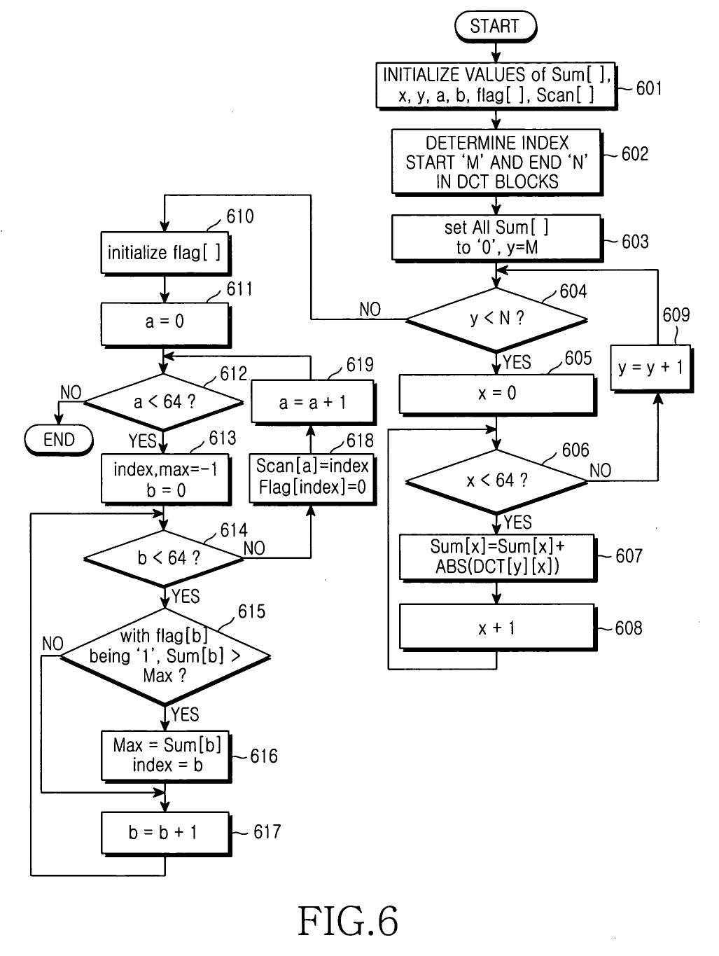

FIG. 6 is a detailed flow chart for explaining a process of the generating method of a scan table explained in FIG. 5 when the generating method is applied to an 8×8 video. Referring to FIG. 6, in step 601 the generating method of a scan table applied to an 8×8 video initializes a function ‘Sum [ ]’ for summing coefficients of pixels, a function ‘Scan [ ]’ for determining a sequence for a scan, a function ‘flag [ ]’ for confirming whether or not a process for generating a scan table is performed, ‘y’ representing a video block, ‘x’ representing a position of a pixel in the video block (y), an index ‘a’ for representing a sequence for a scan, and an index ‘b’ for representing a sequence depending on the sums of the coefficients of the pixels in the video block.

Then, an index start block (M) and an index end block (N) of DCT blocks are determined in step 602. This is a step of determining a block group for determining a scan table described at step 501 (FIG. 5).

The function ‘Sum [ ]’ is set to zero, and the ‘y’ representing a video block is set to the ‘M’ in step 603. That is, an operation starts from a video block ‘M’.

Next, in steps 604, 605, 606, 607, 608, and 609, absolute values of coefficients of respective pixels obtained through the DCT are added until the video block (y) becomes the end block ‘N’. The a formula “Sum[x]=Sum[x]+ABS(DCT[y][x])” performed at step 607 may be described as follows.

Each unit video block in a predetermined video block group (M˜N) includes the same number of pixels, which have the identical format in position. Therefore, a pixel (x) corresponding to the same position in respective unit video blocks is represented as ‘DCT[y][x]’. That is, the ‘DCT[y][x]’ means an x^{th} pixel in a unit video block ‘y’. Accordingly, the sum (Sum[x]) of absolute values of coefficients of x^{th} pixels is represented as “the sum (Sum[x]) of absolute values of coefficients of x^{th} pixels to a previous block+an absolute value (ABS(DCT[y][x]) of a coefficient of the x^{th} pixel in a current block”.

When sums of absolute values of coefficients in respective unit blocks have been calculated, the ‘flag [ ]’ is initialized in step 610. Then, the index ‘a’ for representing a sequence for a scan is initialized to zero in step 611.

Next, until the value of the ‘a’ becomes ‘64’, the number of the whole pixels in a unit video block for an 8×8 video in, step 612, both the first ‘index’ and the first maximum value (max) are set to ‘−1’ and the index value ‘b’ for representing a sequence depending on the sums of the coefficients of the pixels in the video blocks is set to zero in step 613.

Then, until the index value ‘b’ becomes ‘64’ (step 614), it is confirmed whether or not ‘Sum [b]’ is larger than a maximum value (max) with ‘flag [b]’ being ‘1’ in step 615. As a result of the confirmation, if the ‘Sum [b]’ is larger than a maximum value (max) with the ‘flag [b]’ being ‘1’, the maximum value is changed to the ‘Sum [b]’ and ‘index’ is set to ‘b’ in step 616.

Steps 614 to 617 are repeated until the index value ‘b’ becomes ‘64’.

Through the above-described steps, a position (b) of a pixel having a maximum value is determined. Therefore, a first Scan [a] is determined as an ‘index’, that is, a position of a pixel having a maximum value of sums of absolute values, and the value of ‘flag [index]’ of the position of the corresponding pixel is set to zero. It is thereby represented that the corresponding pixel has been processed in step 618. Steps 612 to 619 are repeated until the sequence arrives at ‘64’.

According to the process described above, positions of pixels of a unit block in a block group is arranged in sequence according to the magnitudes of the summed absolute.

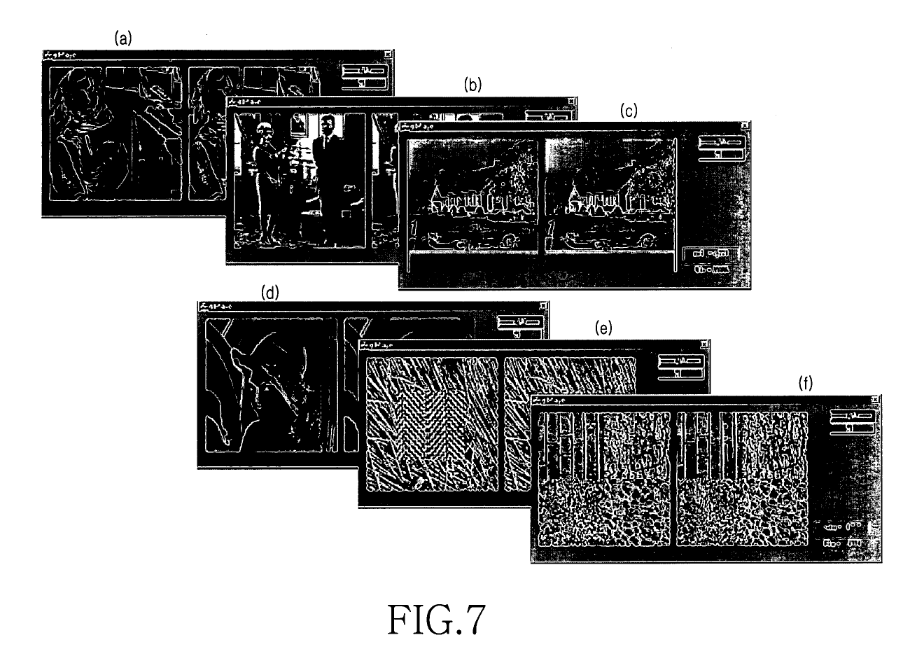

FIGS. 7A to 7F are example views comparing compression ratios of a visual scan method according to the present invention with those of a conventional visual scan method. With respective video as shown in FIGS. 7A to 7F, a comparison result of compression ratios between a visual scan method of the present invention and a scan method of the conventional zigzag process is shown in Tables 1 to 3.

Table 1 shows compression ratios of a visual scan method according to the conventional zigzag process with respect to each of FIGS. 7A to 7F. Each value is the percentage representing the proportion of the amount of bits to raw data.

TABLE 1

| number of | | | | | | |
|---|---|---|---|---|---|---|
| quantization | a | b | c | d | e | f |
| 1 | 24.498 | 21.283 | 24.013 | 16.892 | 58.087 | 55.392 |
| 5 | 5.224 | 4.328 | 4.771 | 3.257 | 16.006 | 14.01 |
| 10 | 2.516 | 2.224 | 2.146 | 1.713 | 7.417 | 5.973 |

Table 2 shows compression ratios of a visual scan method according to the present invention with respect to each of FIGS. 7A to 7F. Each value is the percentage representing the proportion of bit amount to raw data. Table 2 shows an example of using one scan table by the frame.

TABLE 2

| number of | | | | | | |
|---|---|---|---|---|---|---|
| quantization | a | b | c | d | e | f |
| 1 | 24.987 | 21.589 | 24.269 | 16.972 | 58.151 | 55.433 |
| 5 | 5.261 | 4.36 | 4.746 | 3.216 | 15.933 | 13.953 |
| 10 | 2.416 | 2.221 | 2.109 | 1.703 | 7.294 | 5.883 |

Table 3 shows compression ratios of a visual scan method according to the present invention with respect to each of FIGS. 7A to 7F. Each value is the percentage representing the proportion of bit amount to raw data. Table 2 shows an example of using 1024 scan tables by the frame.

TABLE 3

| number of | | | | | | |
|---|---|---|---|---|---|---|
| quantization | a | b | c | d | e | f |
| 1 | 21.248 | 18.558 | 21.159 | 14.362 | 54.787 | 52.229 |
| 5 | 3.727 | 3.435 | 3.656 | 2.687 | 12.655 | 11.072 |
| 10 | 1.905 | 1.901 | 1.828 | 1.568 | 5.597 | 4.519 |

As described above, according to the present invention, it is possible to determine an exact scan method according to blocks in DCT even in special circumstances.

According to the present invention, a greater compression ratio can be obtained, without adding many additional operations to the operations in the conventional methods, even when no existing zigzag scan method nor similar technologies are employed.

The method according to the present invention can be realized by a program and can be stored in a recording medium (such as a CD ROM, a RAM, a floppy disk, a hard disk, an optical and magnetic disk, etc.) in a format that can be read by a computer.

While the invention has been shown and described with reference to certain preferred embodiments thereof, it will be understood by those skilled in the art that various changes in form and details may be made therein without departing from the spirit and scope of the invention as defined by the appended claims.

1. A discrete cosine transform device using a scan table, performing discrete cosine transform (DCT) of input video, quantizing the discrete-cosine-transformed video, scanning the quantized video according to a scan method, and outputting the scanned video as a compressed video stream through a variable length coding (VLC), the discrete cosine transform device comprising:
a scan table generation section for accumulatively summing absolute values of coefficients obtained through a DCT operation, in such a manner that the absolute values in pixels located at the same position of each unit video block in a predetermined video block group are summed together by the predetermined video block group with respect to an input video, and generating a scan table according to magnitudes of the summed absolute values;
a bit-rate calculation section for calculating an amount of bits by accumulatively summing only bit lengths from a VLC table, the VLC table being obtained from values arranged according to the scan table generated in the scan table generation section; and
a scan control section for receiving the input video, the input video having been discrete-cosine-transformed, inputting the received video to the scan table generation section to generate a scan table by the predetermined video block group, receiving a value of a bit rate according to generation of the scan table from the bit-rate calculation section, and performing a control operation using capacity increase of the scan table and the bit rate to provide a scan table for scanning according to the scan method.

2. The discrete cosine transform device as claimed in claim 1, wherein the scan control section changes the predetermined video block group from a minimum unit video block group to a maximum video block group, inputs the predetermined video block group to the scan table generation section, and receives values of bit rates from the bit-rate calculation section.

3. The discrete cosine transform device as claimed in claim 2, wherein the scan control section stores capacity values of data of the scan table generated in the scan table generation section depending on the change of the predetermined video block groups.

4. The discrete cosine transform device as claimed in claim 3, wherein the scan control section sums the capacity value of data of the stored scan table and a value of bit rate of the bit-rate calculation section corresponding to the stored scan table according to the change of the predetermined video block groups, and performs a control operation so that a scan table having a minimum sum is provided as the scan method.

5. A visual scan method using a scan table in order to transmit a compressed video, the visual scan method comprising the steps of:
(1) receiving a discrete-cosine-transformed video for transmission of the compressed video;
(2) determining a block group of a predetermined unit with respect to the received discrete-cosine-transformed video;
(3) accumulatively summing and storing absolute values of coefficients obtained through a DCT process in such a manner that the absolute values in pixels located at the same position of each unit video block in a predetermined video block group are summed together and stored;
(4) rearranging pixels in sequence of magnitudes of the summed absolute values according to positions of the pixels in a unit block, thereby generating a scan table; and
(5) scanning the video according to the generated scan table.

6. The visual scan method as claimed in claim 5, further including the steps of:
(6) repeating steps (3) and (4) while changing the predetermined video block group, thereby generating an optimum scan table; and
(7) scanning the video according to the optimum scan table.
